(19) United States
(12) Patent Application Publication
(10) Pub. No.: US 2023/0381577 A1
(43) Pub. Date: Nov. 30, 2023

(54) Pilates Exercise Machines With Massage Function

(71) Applicant: Chongqing Houxuan Network Technology Co., Ltd, Chongqing (CN)

(72) Inventor: Rongrong Mao, Chongqing (CN)

(21) Appl. No.: 18/326,408

(22) Filed: May 31, 2023

(30) Foreign Application Priority Data
May 31, 2022 (CN) 202221351662.X

(51) Int. Cl. A63B 22/00; A63B 22/02; A63B 21/005; A63B 21/00; A63B 71/06; A63B 21/02; A63B 21/04

(52) U.S. Cl. CPC A63B 22/0089; A63B 22/0235; A63B 21/0058; A63B 21/154; A63B 21/4045; A63B 71/0619; A63B 21/023; A63B 21/0407; A63B 2225/12; A63B 2213/00; A63B 2208/0238

(57) ABSTRACT

In some embodiments, a Pilates exercise machine can include a sliding carriage and a massage module. In some embodiments, the sliding carriage comprises a box frame and a support plate. In some embodiments, the box frame is configured to have a space to accommodate the massage module. In some embodiments, In some embodiments, the Pilates exercise machine can include a display screen and/or a mirror. In some embodiments, the Pilates exercise machine can be used to perform at least one weight training exercise. In some embodiments, the Pilates exercise machine includes a digital weight.

### CROSS-REFERENCE TO RELATED APPLICATION(S)

This Patent Application claims priority to Chinese Patent Application No. 202221351662.X, filed on May 31, 2022, and entitled “PILATES BODY SHAPING MACHINE WITH MASSAGE FUNCTION”. The '662 application is hereby incorporated by reference herein in its entirety.

### FIELD OF THE INVENTION

The present disclosure relates to fitness equipment. In particular, the present disclosure relates to Pilates exercise machines.

Traditional Pilates exercise machines, also known as reformers, core beds or Pilates beds, only allow for exercising the body. If the user needs or wants to massage their bodies, they must use a separate massage bed and/or massage chair. Similarly, if a user wants to perform weightlifting exercises, they must use a separate machine. Currently fitness studios or home gyms looking to incorporate massage devices, Pilates exercise machines, and weightlifting machines, are required to dedicate floor space to multiple machines.

What is needed is a Pilates exercise machine that combines the features of massage equipment with massage functions and/or allows a user to also practice weightlifting exercises.

### SUMMARY OF THE INVENTION

In some embodiments, a Pilates exercise machine can include a sliding carriage, a massage module, a motor, an insertable shoulder rest, a pulley, a rope, and/or a tower. In some embodiments, the sliding carriage can include a box frame; and a support plate.

In some embodiments, the box frame is configured to have a space to accommodate the massage module. In some embodiments, the support plate can be moved to reveal the massage module.

In some embodiments, the support plate is connected to a track, such that the support plate can be moved to a second position so a user can utilize the massage module.

In some embodiments a display screen and/or a mirror is located on the tower.

In some embodiments, the box frame is attached to a first plurality of springs. In some embodiments, the box frame is attached to a second plurality of springs.

In some embodiments, the first plurality of springs is attached to a front panel. In some embodiments, the second plurality of springs is attached to a back panel.

In some embodiments, an end of the support plate is connected to an end of the box frame by a hinge.

In some embodiments, at least one side of the box frame has a support edge wherein the support plate is connected to the box frame by sliding an insertable shoulder rest through an opening in the support edge and a corresponding opening on the support plate.

In some embodiments, the support edge includes a second opening located at an end opposite of the insertable shoulder rest, and the support plate comprises an insert matching the second opening.

In some embodiments, a box frame is attached to a first end of a compression spring, wherein the second end of the compression spring is attached to a front panel of the Pilates exercise machine. In some embodiments, the box frame is attached to a second spring.

In some embodiments, a button is configured to activate and deactivate the compression spring.

In some embodiments, the pulley is located on a vertical side post. In some embodiments, an end of the rope passes through the pulley and is connected to a handle. In some embodiments, the location of the pulley can be adjusted along a side of the vertical side post.

In some embodiments, the motor is configured to work with a pulley and a rope to create a digital weight.

In some embodiments, an end of the support plate is connected to an end of the box frame by a hinge.

In some embodiments, the massage module performs a massage function, wherein the massage function is one of heating, vibration, rotation of a massage head, and/or up-and-down movement of said massage head.

### BRIEF DESCRIPTION OF THE DRAWINGS

FIG. 1 is a top perspective view of an embodiment of a Pilates exercise machine.

FIG. 2 is a bottom perspective view of an embodiment of a Pilates exercise machine.

FIG. 3 is a perspective view of the front of an embodiment of a Pilates exercise machine with the headrest removed.

FIG. 4 is a perspective view of the front of an embodiment of a Pilates exercise machine with the support plate removed.

FIG. 5 is a top perspective view of an embodiment of a Pilates exercise machine with the massage module removed.

FIG. 6 is a top perspective view of another embodiment of a Pilates exercise machine with adjustable pulleys in an upper position.

FIG. 7 is a top perspective view of the Pilates exercise machine of FIG. 6 with the adjustable pulleys in a lower position.

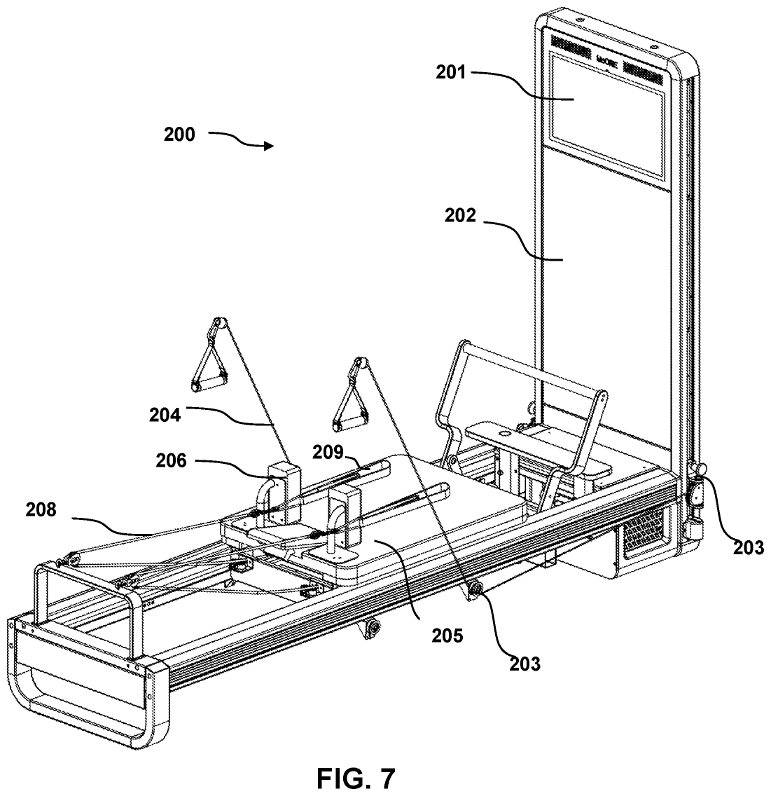

FIG. 8 is a bottom perspective view of another embodiment of a Pilates exercise machine.

FIG. 9 is a bottom perspective view of another embodiment of a Pilates exercise machine.

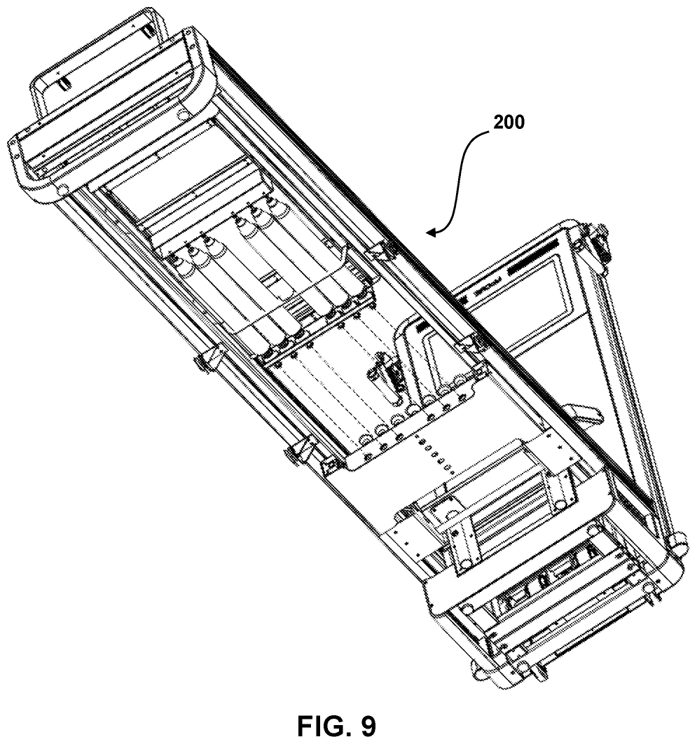

FIG. 10 is a perspective view of the top of another embodiment of a Pilates exercise machine.

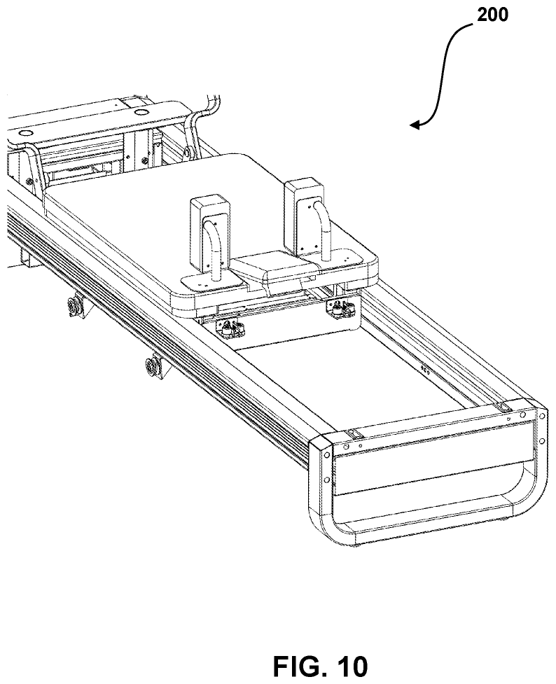

FIG. 11 is a perspective view of the top of another embodiment of a Pilates exercise machine with the support plate removed.

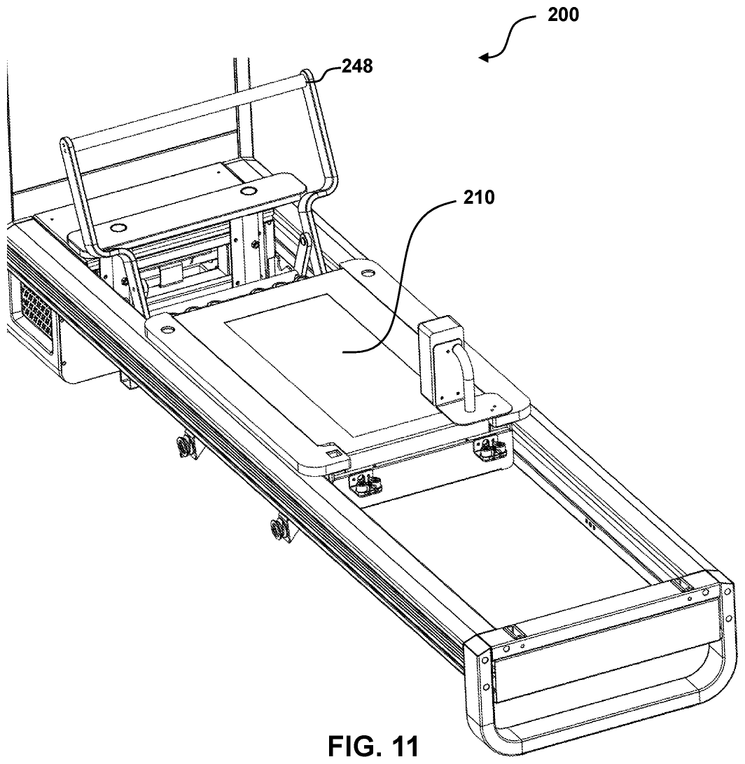

FIG. 12 is a top perspective view of another embodiment of a Pilates exercise machine with the massage module removed.

FIG. 13 is an exploded top perspective view of a Pilates exercise machine showing how the support plate attaches to the Pilates exercise machine.

FIG. 14 is a top perspective view of a Pilates exercise machine with the support plate positioned such that a user can utilize the massage module.

FIG. 15 is a top view of another embodiment of a Pilates exercise machine.

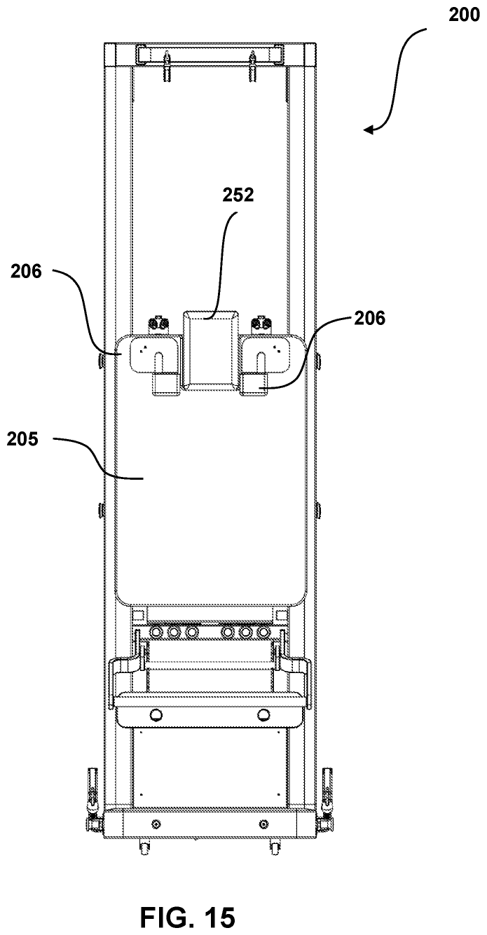

FIG. 16 is a back perspective view of another embodiment of a Pilates exercise machine showing how springs can be activated or deactivated to increase or decrease tension.

FIG. 17 is a perspective view of the bottom of another embodiment of a Pilates exercise machine showing a motor.

### DETAILED DESCRIPTION OF ILLUSTRATIVE EMBODIMENT(S)

A Pilates exercise machine can include at least one massage function. In some embodiments, a Pilates exercise machine includes a sliding carriage and a massage module. In some embodiments, the sliding carriage can include a box frame. In some embodiments, the box frame has space for accommodating the massage module. In some embodiments, the top of the box frame is equipped with a support plate for opening or closing the accommodating space.

In at least some embodiments, at least one massage function can be accomplished on the Pilates exercise machine, thereby removing, or at least reducing the need for a separate massage machine and thereby achieving space savings.

In at least some embodiments, at least one weightlifting function can be accomplished on the Pilates exercise machine, thereby removing, or at least reducing the need for a separate weightlifting machine and thereby achieving space savings.

In at least some embodiments, at least one weightlifting function and at least one massage function can be accomplished on the Pilates exercise machine, thereby removing, or at least reducing the need for separate weightlifting and massage machines and thereby achieving space savings.

In some embodiments, the Pilates exercise machine has a sliding carriage, and a user exercises by sliding the carriage back and forth along the horizontal section of the Pilates exercise machine.

In some embodiments, the massage module is a conventional massage device and has functions such as, but not limited to, heating, vibration, rotation of a massage head, and/or up-and-down movement of a massage head to achieve relaxation of the human body.

In some embodiments, the support plate and the box frame can be connected via various mechanisms such as, but not limited to, hinges. In some embodiments where hinges are used, the support plate can be flipped into a second position when a user wants to use the massage module.

In some embodiments, the support plate is on a track, such that it can be moved from a first position when the machine is being used for Pilates exercises to a second position when the massage module is being used.

In some embodiments, the support plate is simply lifted and placed into a second position.

In some embodiments, the upper end of the accommodating space can be opened and closed by removing the support plate, making it convenient to remove the massage module for quick maintenance and/or replacement. In some embodiments, an exerciser can perform fitness exercises on the support plate, and after finishing the fitness exercises, the support plate can be removed, and the massage module can be used for massage.

In some embodiments, the massage module can work through the support plate, such that the support plate does not need to be removed.

In some embodiments, the support plate is configured to slide horizontally on the box frame. In some embodiments, this makes it convenient to quickly access the massage module and convert the machine from a Pilates form to a massage form.

In some embodiments, the end of the support plate is connected to the end of the box frame with a hinge. In some embodiments, this makes it easy to quickly access the massage module by flipping the support plate up.

In some embodiments, the box frame includes support edges on both sides of the box frame that are configured to slide across the body of the Pilates exercise machine. In some embodiments, the Pilates exercise machine includes an insert shoulder rest. In some embodiments, the insert shoulder rest is attached to the carriage via running one or more bolts associated with the insert shoulder rest through one or more openings on the support edge and one or more corresponding openings on the support plate. In some embodiments, to prevent the support plate from moving, or at least reduce the chance and/or amount of movement, a conventional shoulder rest is replaced with an insert shoulder rest.

In some embodiments, the box frame is configured to move across the body of the Pilates exercise machine via the support edges on both sides. In some embodiments the box frame utilizes wheels in a track on each side to aid in movement of the carriage. In some embodiments, these track/rail systems can utilize several pairs of wheels.

In some embodiments, the end of the support edge opposite the insert shoulder rest also has at least one opening, and the support plate has at least one insert that matches the at least one opening. In some embodiments, the interaction of the insert with the opening prevents, or at least reduces the chance of, the support plate from moving independently of the carriage during exercise. In some embodiments, by hinging and rotating the support plate, the at least one insert can be inserted into the at least one opening to prevent, or at least reduce the chance of, the support plate from moving independently of the carriage during exercise.

In some embodiments, the bottom ends of the box frame are equipped with several compression springs. In some embodiments one end of the compression springs are connected to the bottom of the box frame and the other end of the springs are connected to the body frame, such as a front panel. In some embodiments, the spring force works counter to the direction the carriage is sliding.

In some embodiments, a motor provides a spring-like resistance to the carriage. In some embodiments, the motor is used in connection with springs.

In some embodiments, to allow an exerciser to perform more combination movements, several compression springs are set at both ends of the bottom of the box frame. For example, in some embodiments, a first compression spring can be positioned on one side of the bottom of the box frame and attached to a front panel of the Pilates exercise machine and a second compression spring can be positioned on the other side of the box frame and attached to a back panel. Compared to embodiments that only use a compression spring on one side and hence only provide unidirectional resistance, using springs on both sides of the box frame provides bidirectional resistance. In at least some of these embodiments, this allows for an exerciser to perform more exercise movements. This setup can also lead to a more convenient experience.

In some embodiments, the Pilates exercise machine includes pulleys and ropes. In some embodiments, at least some of the pulleys are located on the tower of the Pilates exercise machine. In some embodiments, the pulleys are located on a vertical side post. In some embodiments, the vertical side post is configured to hold the pulley at various locations.

In some embodiments, one end of a rope is connected to the sliding carriage, while the other end of the rope passes through the pulley and is connected to a handle. In some embodiments, the exerciser holds the handle and stretches the rope causing the sliding carriage to move.

In some embodiments, to match the bidirectional resistance of the sliding carriage, the Pilates exercise machine uses various pulleys and ropes.

In some embodiments, the pulley(s) are slidably connected to the vertical side post(s) of the Pilates exercise machine. In some embodiments, the pulley(s) can move along the vertical side post(s) of the Pilates exercise machine, making it convenient to adjust the height of the pulley(s). In some embodiments, the vertical side posts have channels configured to receive the pulleys. In some embodiments the vertical posts are configured to receive the pulleys at given heights.

In some embodiments, a display screen is provided on the tower of the Pilates exercise machine. In some embodiments, the display screen can provide video guidance to the exerciser.

In some embodiments, the display can include a camera to record a user during exercise. In some embodiments, the display provides suggestions to the user based on the recording. In some embodiments, the display can play music.

In some embodiments, a mirror is provided on the tower of the Pilates exercise machine. In some embodiments, the mirror is located below the display. In at least some embodiments, this makes it easy for an exerciser to observe their exercise movements while interacting with the display.

At least some of the disclosed embodiments of the Pilates exercise machine have one or more of the following advantages and beneficial effects. In some embodiments, the Pilates exercise machine can include a massage function. In these embodiments, traditional Pilates exercises and massage functions can be achieved on the same machine. In some embodiments, the Pilates exercise machine can include bi-directional resistance, which can provide exercisers with more exercise combinations and/or a more convenient experience. In some embodiments by integrating a mirror and display screen functions with the Pilates exercise machine, exercises can be made more autonomous. In some embodiments, by incorporating a motor to add resistance, the Pilates exercise machine can double as a weightlifting machine. In some embodiments, the motor can replace or supplement the use of springs to provide resistance to the movable carriage.

The following illustrative embodiments are used to explain certain embodiments and should not be viewed as limiting.

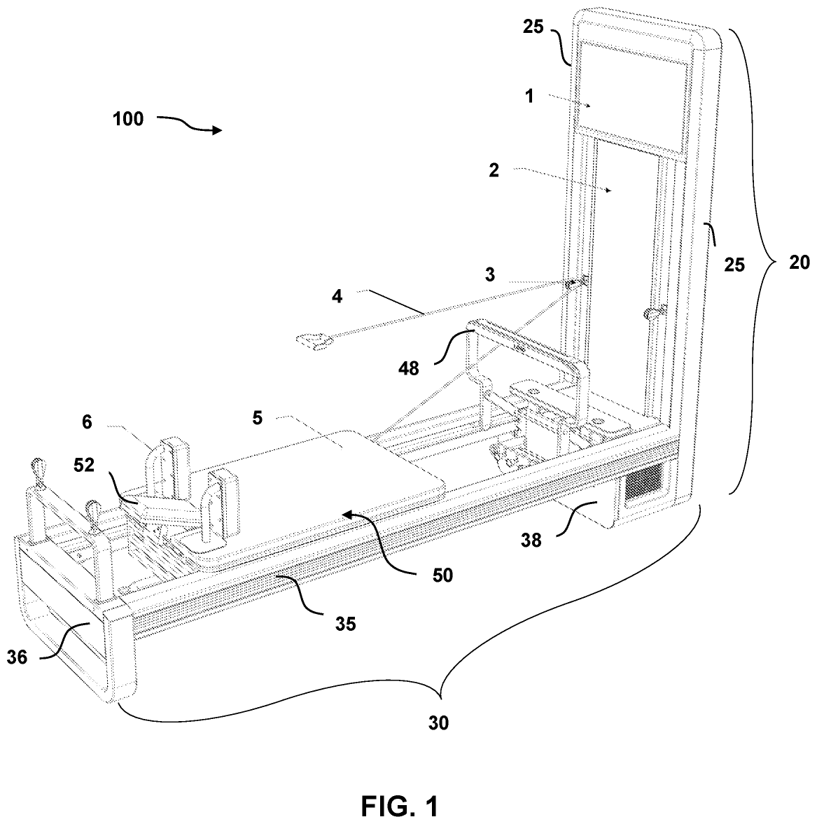

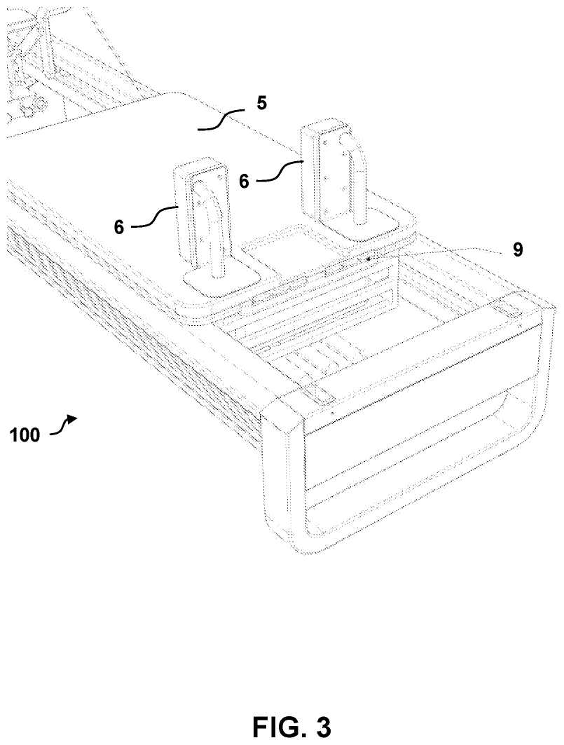

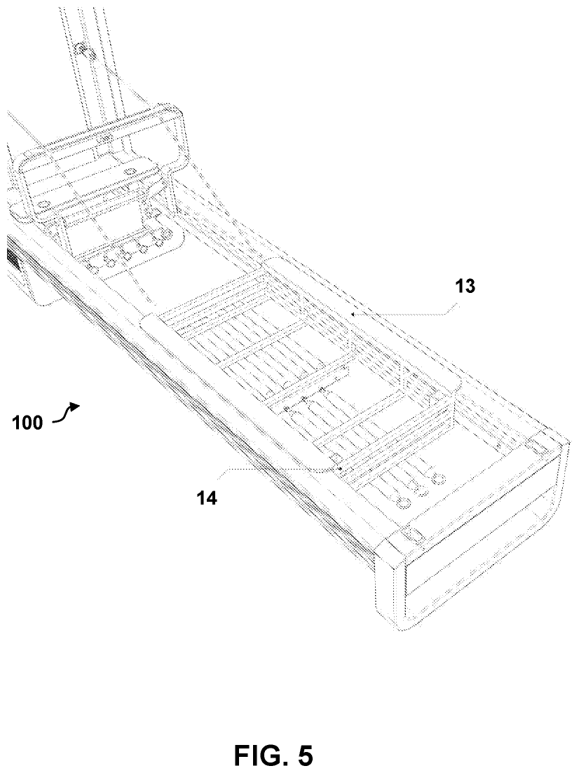

Turning to FIG. 1 to FIG. 5, Pilates exercise machine 100 can include, among other things, sliding carriage 50 and massage module 10. In some embodiments, Pilates exercise machine 100 can be divided into tower 20 and horizontal section 30. In some embodiments, tower 20 includes at least two vertical side posts 25. In some embodiments, horizontal section 30 includes sliding carriage 50, body frame 35, front panel 36, back panel 38 and foot bar 48.

In some embodiments, tower 20 is located at the end near foot bar 48, such as shown in FIG. 1. In some embodiments, tower 20 is located at the end near front panel 36. In some embodiments, Pilates exercise machine 100 is configured such that the position of tower 20 is adjustable. For example, a user may wish to change the position of tower 20 depending on the exercise being performed.

In some embodiments, foot bar 48 is adjustable in the horizontal direction. In some embodiments, foot bar 48 is adjustable in the vertical direction. In some embodiments, foot bar 48 is adjustable in both the horizontal and vertical directions.

In at least some embodiments, Pilates exercise machine 100 includes a massage function. In some embodiments, this massage function is conducted via massage module 10. In some embodiments, massage module 10 is a conventional massage device that can provide functions such as, but not limited to, heating, vibration, rotation of a massage head, and/or up-and-down movement of a massage head to achieve relaxation of the human body.

In some embodiments, during use, an exerciser can exercise on support plate 5. In some embodiments, after the exerciser has completed the exercise, support plate 5 can be moved, and the exerciser can receive a massage via massage module 10.

In some embodiments, Pilates exercise machine 100 includes sliding carriage 50, which allows an exerciser to exercise by moving sliding carriage 50 back and forth. In some embodiments, sliding carriage 50 can include box frame 14, which, in at least some embodiments, has a housing space for accommodating massage module 10. In some embodiments, the top of the box frame 14 utilizes support plate 5 for opening and/or closing the housing space. In some embodiments, support plate 5 is provided at the upper end of the housing space, such that it can support an exerciser. In some embodiments, support plate 5 can be connected to box frame 14 in various ways, such as, but not limited to, a hinge or bolts. In at least some embodiments, support plate 5 allows for the closure and opening of the upper end of the housing space, making it easy to use, remove, replace, and/or perform maintenance on massage module 10. In some embodiments, support plate 5 has headrest 52.

In some embodiments, support plate 5 can slide horizontally to facilitate quick accesses massage module 10. In some embodiments, the end of support plate 5 is connected to an end of box frame 14 through hinge 9. In at least some embodiments, this facilitates quick opening of box frame 14 by allowing support plate 5 to flip up.

In some embodiments, two sides of box frame 14 are provided with support edges 13 that are configured to slide across body frame 35 of Pilates exercise machine 100. In some embodiments, box frame 14 has wheels that fit into tracks located on body frame 35.

In some embodiments, to prevent, or at least reduce support plate 5 from opening and/or moving independently of sliding carriage 50, insertable shoulder rest 6 can be used. In some embodiments, a peg on insertable shoulder rest 6 passes through openings on support plate 5 and continues passing through openings 12 on support edges 13 to help attach support plate 5 to box frame 14. In some embodiments, this prevents upper support plate 5 from moving independently of sliding carriage 50.

In some embodiments, a conventional shoulder rest is replaced with insertable shoulder rest 6. In some embodiments there are multiple openings 12 on one or both support edges 13. In some embodiments, there are corresponding openings on support plate 5.

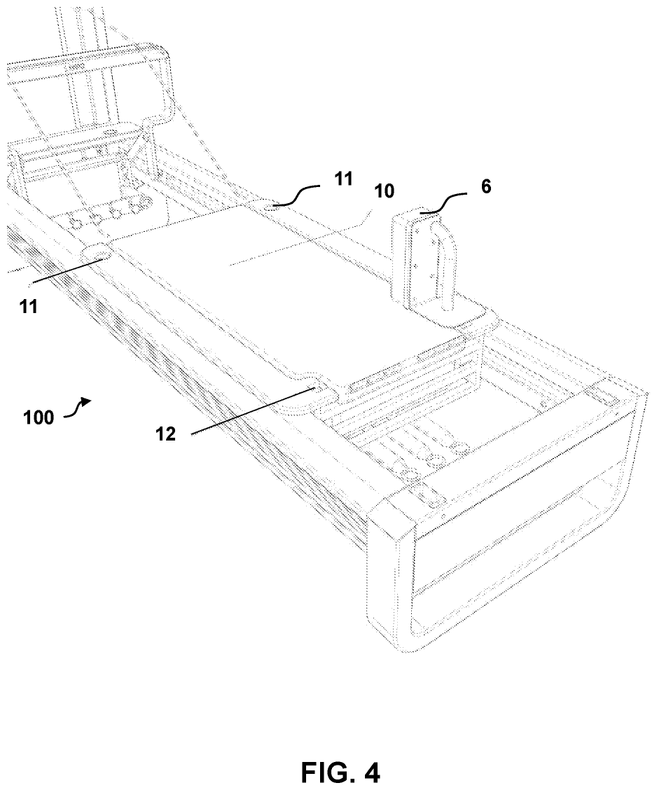

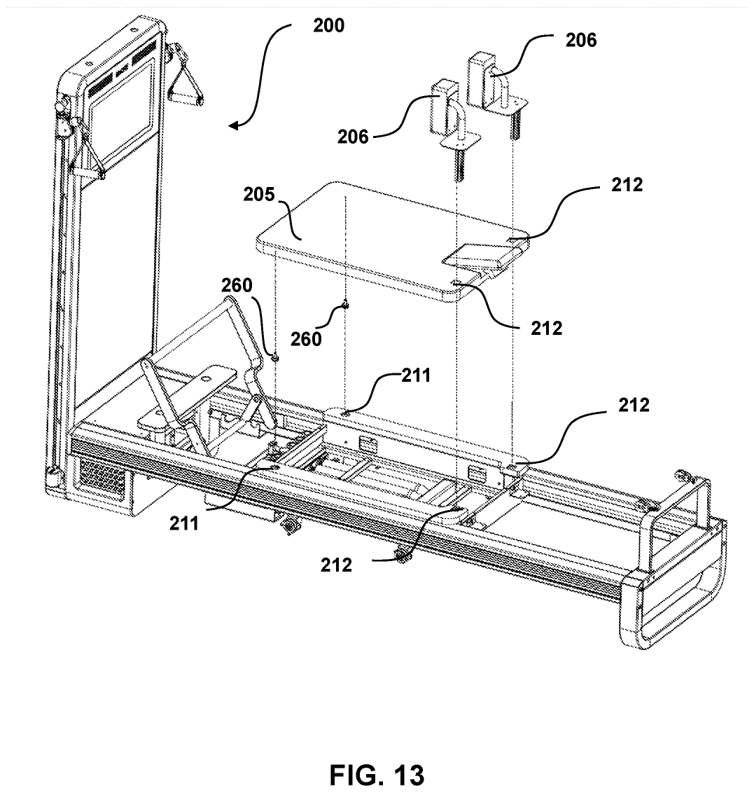

In some embodiments, such as shown in FIG. 4, opening 11 can be utilized to prevent, or at least reduce the sideways movement of support plate 5 during exercise. In some embodiments, support edge 13 includes opening 11 that can interact with insertable pegs. A version of this type of configuration is illustrated in the exploded view of FIG. 13. In some embodiments, pegs are attached to support plate 5 such that the pegs on support plate 5 can be lowered into openings 11 when support plate 5 is being positioned so that Pilates exercise machine 100 can be used to perform Pilates exercises.

In some embodiments, opening 11 is located on support edges 13 at the end opposite to insertable shoulder rest 6 and opening 12. In some embodiments, an insert piece and/or peg is provided at the corresponding position of support plate 5. In some embodiments, by rotating support plate 5 via the hinge and inserting the insert piece into opening 11, the sideways movement of support plate 5 can be prevented, or at least reduced.

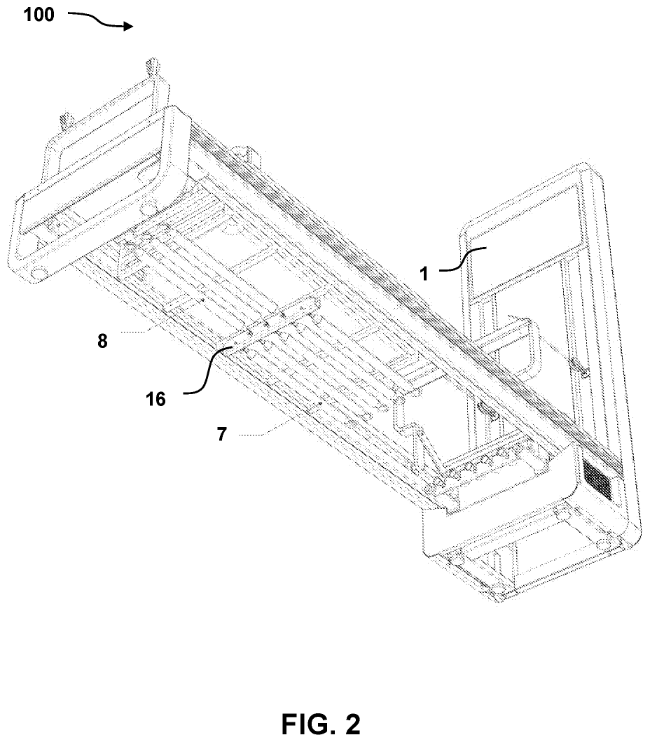

In some embodiments, such as shown in FIG. 2, Pilates exercise machine 100 includes a plurality of compression springs. In some embodiments, the compression springs are located at a front end of the bottom of box frame 14 and a back end of the bottom of box frame 14. In some embodiments, the ends of compression spring 8 and compression springs 7 are respectively connected to the front end of box frame 14 and front panel 36 and the back end of box frame 14 and back panel 38. In some embodiments, the ends of compression spring 8 and compression springs 7 are respectively connected to one side of spring bar 16 and front panel 36 and the other side of spring bar 16 and back panel 38. In some embodiments, compression spring 8 and compression spring 7 are configured such that the spring force acts in the sliding direction of sliding carriage 50.

In some embodiments, such as the one shown in FIG. 2, multiple pluralities of compression springs are provided at both ends of the bottom of box frame 14. For example, a first plurality of springs includes first compression spring 7 attached to one side of spring bar 16 and back panel 38 and a second plurality of springs includes second compression spring 8 attached to another side of spring bar 16 and front panel 36 on the other side of the bottom of box frame 14. In at least some embodiments, placing springs on both sides of box frame 14 provides bidirectional resistance. In some embodiments, this allows exercisers to accomplish different exercise combinations than if resistance is only available in one direction.

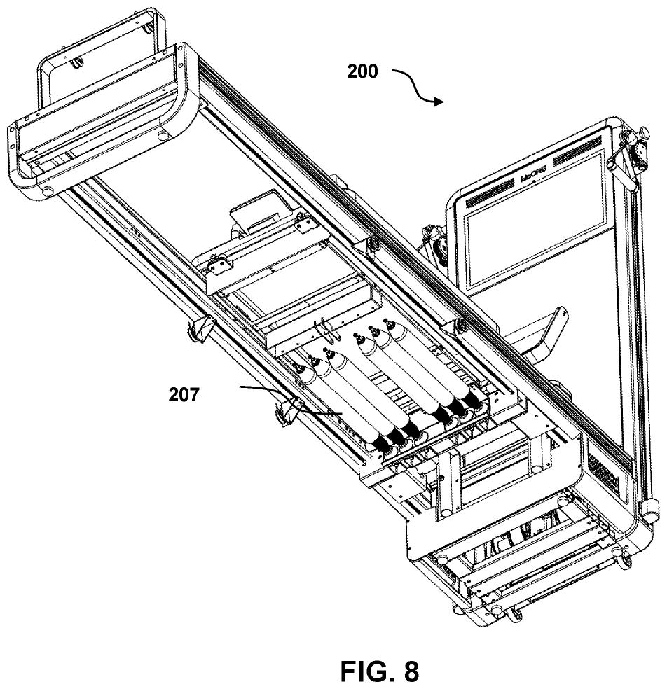

In some embodiments, such as the one shown in FIG. 8, a single plurality of springs is used. In some embodiments, a single spring can be used instead of a plurality of springs. In some embodiments, a single spring can be located on each side of box frame 14 to allow for bidirectional resistance.

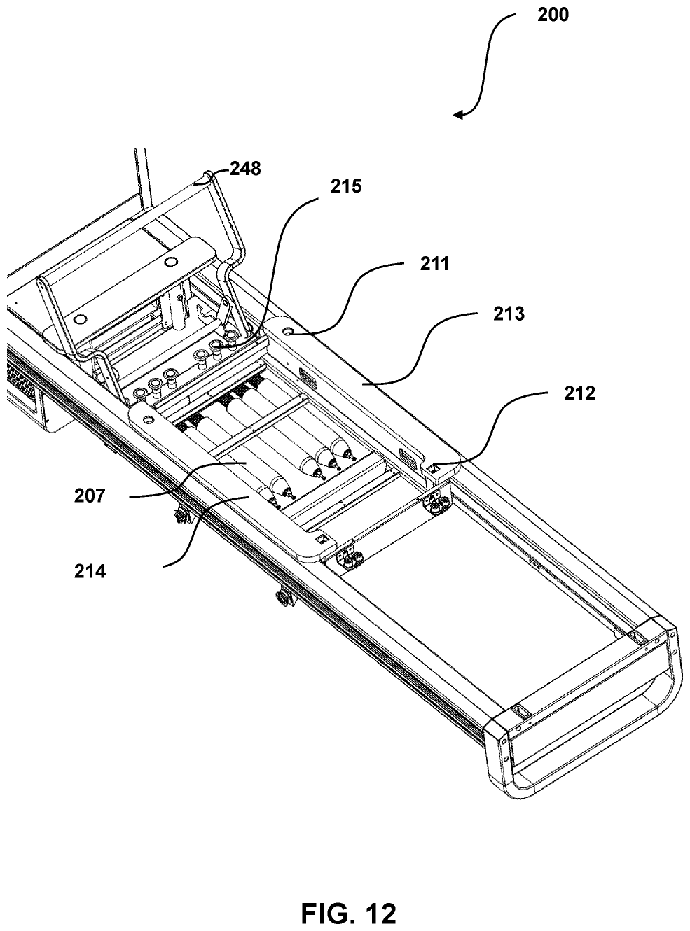

In some embodiments, such as the one shown in FIG. 12, at least one button 215 can be used to activate or deactivate one of more springs 207, such that the spring load can be adjusted. In some embodiments, spring bar/gear bar 216 is utilized. In some embodiments, the position of spring bar/gear bar 216 can be adjusted to modify spring resistance.

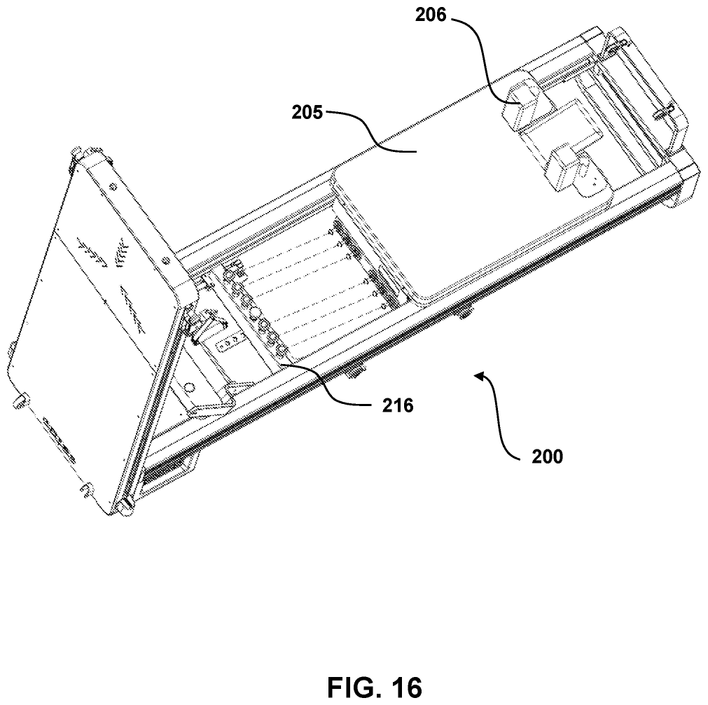

In some embodiments, such as the one shown in FIG. 16, a pin can be used to move the position of spring bar/gear bar 216 move back and forth so to adjust the tension of all the springs.

In some embodiments, springs with different spring rates can be utilized on the same Pilates exercise machine.

In some embodiments, Pilates exercise machine 100 includes one or more pulleys 3 and one or more ropes 4. In some embodiments, at least one pulley 3 is located on vertical side post 25 of Pilates exercise machine 100. In some embodiments, at least one rope 4 is connected to a motor to provide resistance to rope 4. In some embodiments, various attachments, such as but not limited to handles and exercise bars, can be attached to one end of rope 4 to allow for various exercises, including weightlifting exercises.

In some embodiments, at least one pulley 3 is adjustable. In some embodiments, at least one pulley 3 is configured to slide in a channel in vertical side post 25 such that the height of at least one pulley 3 can be adjusted along vertical side post 25. In some embodiments, vertical side post 25 can have various openings for receiving a pin associated with at least one pulley 3 to lock the at least one pulley 3 in place.

In some embodiments, such as the one shown in FIG. 1, display screen 1 is located on the vertical side of the machine body. In at least some embodiments, this enables an exerciser to obtain video guidance.

In some embodiments, Pilates exercise machine 100 includes mirror 2. In some embodiments, mirror 2 is located on tower 20. In at least some embodiments, mirror 2 allows an exerciser to see their own movements. In some embodiments, mirror 2 is installed below display screen 1. In some embodiments, by integrating the functions of mirror 2 and display screen 1 with Pilates exercise machine 100, an exerciser can have a more autonomous exercise experience.

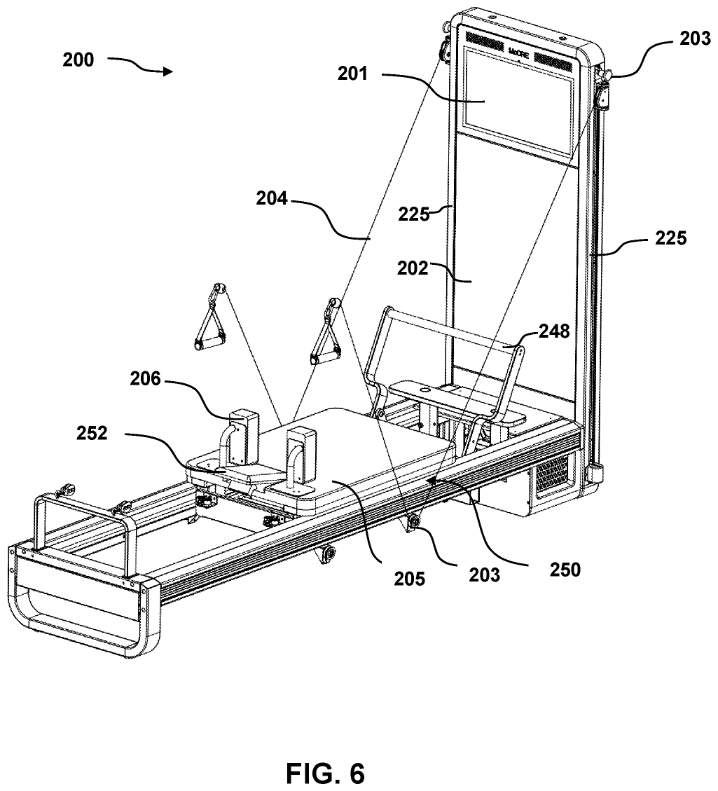

FIG. 6 illustrates an embodiment of Pilates exercise machine 200. In some embodiments, Pilates exercise machine 200 includes mirror 202, display screen 201, foot bar 248, rope 208 and/or massage module 210.

In some embodiments, foot bar 248 is adjustable in the horizontal direction. In some embodiments, foot bar 248 is adjustable in the vertical direction. In some embodiments, foot bar 248 is adjustable in both the horizontal and vertical directions.

In some embodiments, Pilates exercise machine 200 includes at least one pulley 203 and/or at least one rope 204. In some embodiments, at least one rope 204 is connected to motor 240 to provide resistance to rope 204. In some embodiments, various attachments, such as but not limited to handles and exercise bars, can be attached to one end of rope 204 to allow for various exercises, including weightlifting exercises.

In some embodiments, at least one pulley 203 is located on vertical side post 225 of Pilates exercise machine 200.

In some embodiments, at least one pulley 203 is adjustable. In some embodiments, at least one pulley 203 is configured to slide in channel in vertical side post 225 such that the height of at least one pulley 203 can be adjusted along vertical side post 225. In some embodiments, vertical side post 225 can have various openings for receiving a pin associated with at least one pulley 203 to lock the at least one pulley 203 in place.

In some embodiments, one end of rope 208 is connected to sliding carriage 250, while the other end of rope 208 passes through at least one pulley and is connected to handle 209. In some embodiments, the exerciser can grip the handle and pull rope 208 to move sliding carriage 250.

In some embodiments, Pilates exercise machine 200 includes at least one insertable shoulder rest 206 and/or an opening 212 configured to receive insertable shoulder rest 206. In some embodiments, Pilates exercise machine 200 includes box frame 214.

In at least some embodiments, box frame 214 is configured to slide on horizontal section of Pilates exercise machine 200. In some embodiments there are multiple openings 212 on one or both support edge(s) 213. In some embodiments, there are corresponding openings 212 on support plate 205. In some embodiments, insertable shoulder rest 206 passes through upper and lower openings 212 and is fixed on support plate 205. In some embodiments, this prevents upper support plate 205 from moving independently of carriage 250. In some embodiments, opening(s) 211 can be utilized to prevent, or at least reduce the sideways movement of support plate 205 during exercise. In some embodiments, support edge 213 includes opening(s) 211 that can interact with insert piece 260. In some embodiments, insert piece 260 is attached to, or a part of, support plate 205.

In some embodiments, opening 211 is located on support plate 205 at the end opposite to insertable shoulder rest 206 and opening 212. In some embodiments, insert piece 260 is provided at the corresponding position of support plate 205. In some embodiments, by rotating support plate 205 via a hinge and inserting insert piece 260 into opening 211, the sideways movement of support plate 205 can be prevented, or at least reduced.

In some embodiments, support plate 205 includes headrest 252.

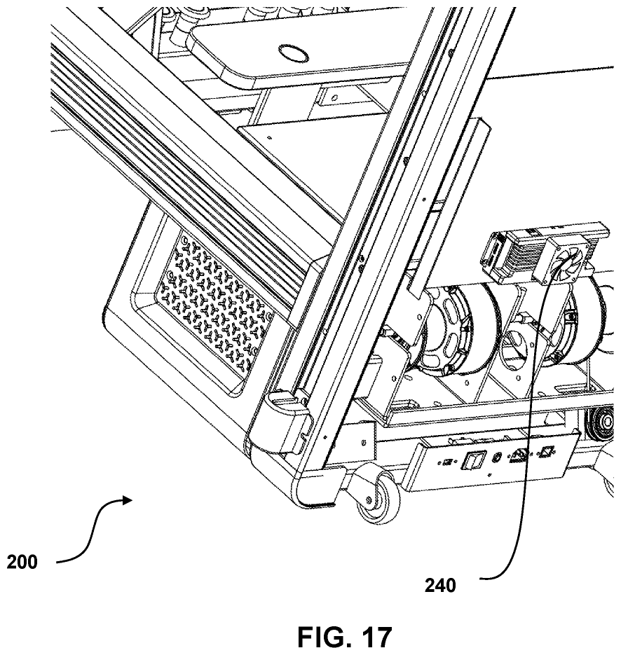

In some embodiments, such as shown in FIG. 17 with respect to Pilates exercise machine 200, Pilates exercise machine 200 can include motor 240 connected to at least one rope and at least one pulley. In some embodiments, the addition of motor 240 allows Pilates exercise machine 200 to be used for weight training, as the resistance on rope 204 can be adjusted to mimic traditional weight-based machines and/or exercises.

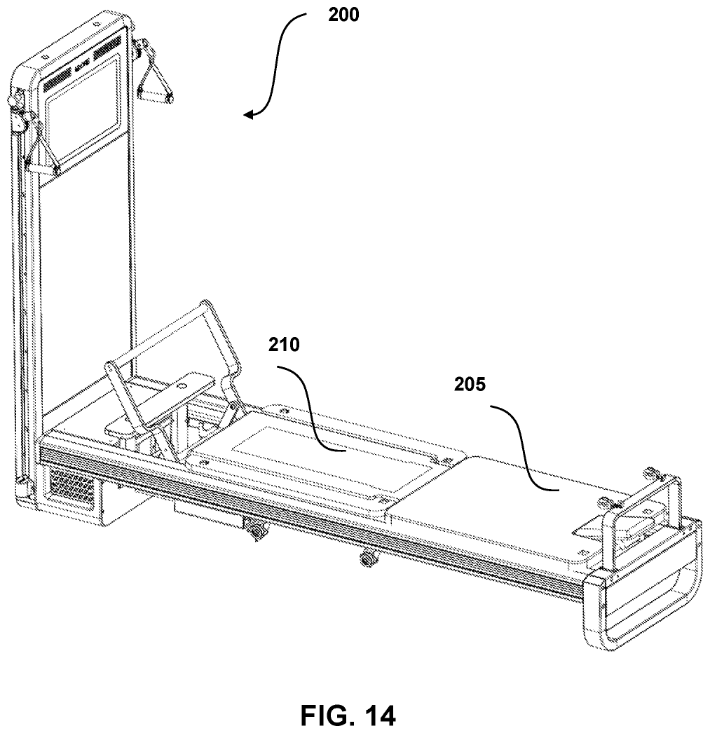

In some embodiments, support plate 205 is located in the position shown in FIG. 14 when Pilates exercise machine 200 is being used to perform weight training exercises. In some embodiments, this arrangement prevents, or at least reduces, movement from sliding carriage 250.

In some embodiments, the use of motor 240 replaces the use of compression springs. In some embodiments, compression springs are used in connection with motor 240 to provide resistance. In some embodiments, motor 240 is an electric motor.

In some embodiments, motor 240 can be used to achieve a “digital weight”. In some embodiments, Pilates exercise machine 200 automatically adjusts the resistance of the digital weight based on the exercise being performed. In some embodiments this is done via a user interface.

In some embodiments, Pilates exercise machine 200 can adjust the resistance during an exercise. In some embodiments, this is done in response to data collected by Pilates exercise machine 200. For example, in some embodiments, Pilates exercise machine 200 can detect that a user is fatiguing and decrease the resistance so the user can finish the set.

The above-described embodiments have provided a further detailed description of the purpose, technical solution, and beneficial effects of at least some embodiments of the inventions. It should be understood that the above-described embodiments are merely specific embodiments and are not intended to limit the disclosure. Modifications, equivalent replacements, improvements, etc., made within the spirit and principles of the disclosure should be included within the scope of the disclosure.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

It should be understood that the specific embodiments described above are merely illustrative and are not intended to limit the scope of this disclosure. Any modifications, equivalent replacements, improvements, etc. made within the spirit and principles of the present disclosure should be included within the scope of protection of the present disclosure.

While particular elements, embodiments and applications of the present inventions have been shown and described, it will be understood, that the inventions are not limited thereto since modifications can be made without departing from the scope of the present disclosure, particularly in light of the foregoing teachings.

What is claimed is:

1. A Pilates exercise machine comprising:
a sliding carriage comprising:
a box frame; and
a support plate; and
a massage module,
wherein said box frame is configured to have a space to accommodate said massage module,
wherein said support plate can be moved to reveal said massage module.

2. The Pilates exercise machine of claim 1, wherein said support plate is connected to a track, such that said support plate can be moved to a second position so a user can utilize said massage module.

3. The Pilates exercise machine of claim 1, wherein a display screen is located on a tower of said Pilates exercise machine.

4. The Pilates exercise machine of claim 1, wherein a mirror is located on a tower of said Pilates exercise machine.

5. The Pilates exercise machine of claim 1, wherein said box frame is attached to a first plurality of springs,
wherein said box frame is attached to a second plurality of springs,
wherein said first plurality of springs is attached to a front panel, and
wherein said second plurality of springs is attached to a back panel.

6. The Pilates exercise machine of claim 1, further comprising a motor.

7. The Pilates exercise machine of claim 1, wherein an end of said support plate is connected to an end of said box frame by a hinge.

8. The Pilates exercise machine of claim 7, further comprising
an insertable shoulder rest,
wherein at least one side of said box frame has a support edge wherein said support plate is connected to said box frame by sliding said insertable shoulder rest through an opening in said support edge and a corresponding opening on said support plate.

9. The Pilates exercise machine of claim 8, wherein said support edge comprises a second opening located at an end opposite said insertable shoulder rest, and said support plate comprises an insert matching said second opening.

10. The Pilates exercise machine of claim 1, wherein said box frame is attached to a first end of a compression spring, wherein a second end of said compression spring is attached to a front panel.

11. The Pilates exercise machine of claim 10 wherein a button is configured to activate and deactivate said compression spring.

12. The Pilates exercise machine of claim 10, further comprising a second compression spring.

13. The Pilates exercise machine of claim 10, further comprising:
a pulley; and
a rope,
wherein said pulley is located on a vertical side post,
wherein an end of said rope passes through said pulley and is connected to a handle.

14. The Pilates exercise machine of claim 13, wherein a location of said pulley can be adjusted along a side of said vertical side post.

15. The Pilates exercise machine of claim 13, wherein a mirror is located on a tower of said Pilates exercise machine.

16. The Pilates exercise machine of claim 1, further comprising:
a pulley; and
a rope.

17. The Pilates exercise machine of claim 16, wherein an end of said support plate is connected to an end of said box frame by a hinge; and
wherein a location of said pulley can be adjusted along a vertical side post.

18. The Pilates exercise machine of claim 17, wherein a display screen and a mirror are located on a tower of said Pilates exercise machine.

19. The Pilates exercise machine of claim 17, further comprising a motor that is configured to work with said pulley and said rope to create a digital weight.

20. The Pilates exercise machine of claim 1, wherein said massage module performs a massage function, wherein said massage function is one of heating, vibration, rotation of a massage head, and/or up-and-down movement of said massage head.
